(19) United States
(12) Patent Application Publication
(10) Pub. No.: US 2006/0080714 A1
(43) Pub. Date: Apr. 13, 2006

(54) Apparatus and method for facilitating connection of an electronic device with an audiovisual system

(76) Inventor: Lee W. Atkinson, Taipei (TW)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/964,251

(22) Filed: Oct. 12, 2004

(51) Int. Cl. H04N 7/173; H04N 7/18

(52) U.S. Cl. 725/80; 725/100; 725/131

(57) ABSTRACT

An electronic device such as a notebook computer is configured to facilitate connection of the device with an audiovisual system such as a home theater system by the inclusion of an output port (a DIN connector having at least five electrical contacts) that outputs S-Video-compatible video, digital audio, and, in some embodiments, composite video.

### FIELD OF THE INVENTION

The present invention relates generally to electronic devices that output audio and video and more specifically to techniques for facilitating the connection of such a device with an audiovisual system.

### BACKGROUND OF THE INVENTION

A variety of electronic devices such as notebook computers have audio and video output ports. One popular format in which video is output from such devices is Separated Video (S-Video). Digital audio may also be output from the device. One popular format is the popular Sony-Philips Digital Interface Format (SPDIF). In notebook computers, SPDIF audio output is usually available only if the device is docked (e.g., connected with a port replicator). Due to space limitations, SPDIF audio is rarely passed over its own dedicated port.

The above configuration renders somewhat inconvenient the connection of an electronic device such as a notebook computer with an audiovisual system such as a home theater system. Even if a dedicated SPDIF port happens to be available on the electronic device, a user must still connect two separate cables between the device and the audio visual system: one for S-Video and another for the SPDIF audio. Since electronic devices such as notebook computers are portable and are intended to be connected with and disconnected from peripherals frequently, the extra hassle of dealing with two separate cables can become significant to the user over time.

It is thus apparent that there is a need in the art for an improved method and apparatus for facilitating connection of an electronic device with an audiovisual system.

### SUMMARY OF THE INVENTION

A method for facilitating connection of an electronic device with an audiovisual system is provided. An electronic device having an output port that facilitates connection of the electronic device with an audiovisual system is also provided.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 is a functional block diagram of an electronic device in accordance with an illustrative embodiment of the invention.

FIG. 2 is an illustration showing a rear view of an electronic device in accordance with an illustrative embodiment of the invention.

FIG. 3 is an illustration of an output port of an electronic device in accordance with an illustrative embodiment of the invention.

FIGS. 4A-4C are illustrations of an output port of an electronic device in accordance with three different illustrative embodiments of the invention.

FIG. 5 is a flowchart of a method for facilitating connection of an electronic device with an audiovisual system in accordance with an illustrative embodiment of the invention.

FIG. 6 is a block diagram of an electronic device connected with an audiovisual system in accordance with an illustrative embodiment of the invention.

### DETAILED DESCRIPTION OF THE INVENTION

S-Video Deutsches Institut für Normung (DIN) connectors with five or seven pins are currently available. Since only four pins are needed to carry S-Video signals (luma, chroma, and two ground pins), some pins remain unused. One or more of those unused pins may be used to carry digital audio over the same physical cable as the S-Video signals. This allows a single cable to be connected between an electronic device such as a notebook computer and an audiovisual system such as a home theater system. In some applications, the single cable may split into a “Y” at the audiovisual-system end to allow connection with separate audio and video inputs of the audiovisual system. Connection of a single cable between the devices is more convenient for the user than using two separate cables for video and audio.

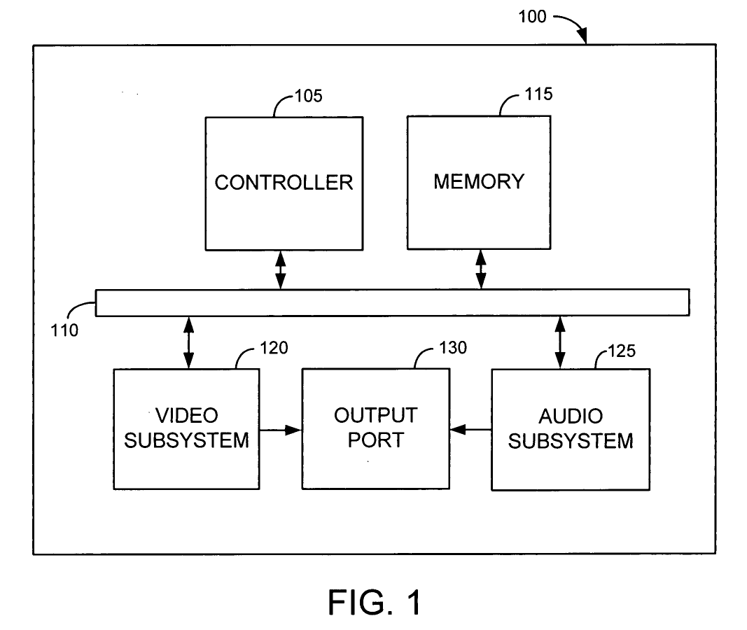

FIG. 1 is a functional block diagram of an electronic device 100 in accordance with an illustrative embodiment of the invention. Electronic device 100 may be any electronic device capable of outputting video and digital audio. A notebook computer is merely one example. In FIG. 1, controller 105 communicates over data bus 110 with memory 115, video subsystem 120, and audio subsystem 125. Video subsystem 120 and audio subsystem 125 are in turn electrically connected with output port 130. Audio subsystem 125 includes an audio codec (not shown in FIG. 1) that outputs digital audio. In some embodiments, the audio codec may comprise an SPDIF transmitter. However, the principles of the invention are applicable to any other serial multiplexed digital audio format, and all such formats are considered to be within the scope of the invention as claimed.

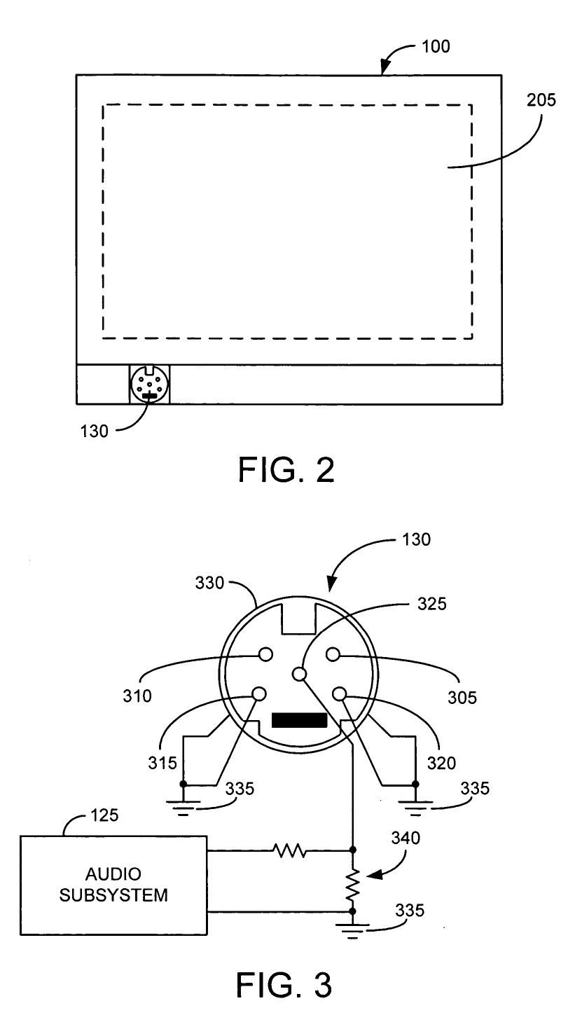

FIG. 2 is an illustration showing a rear view of electronic device 100 in accordance with an illustrative embodiment of the invention. In the particular embodiment shown in FIG. 2, electronic device 100 is depicted as a notebook computer with output port 130 and display 205.

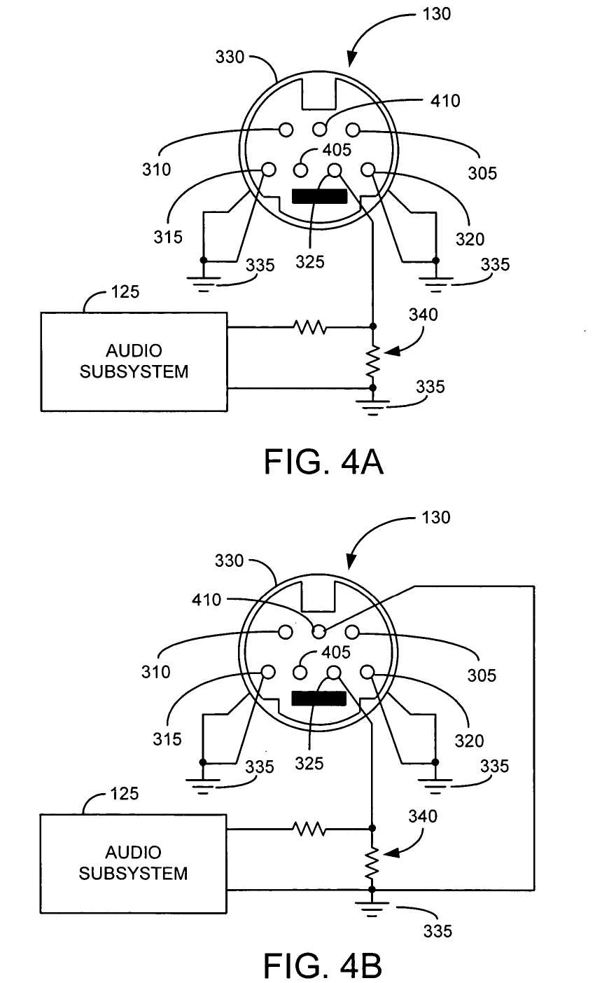

FIG. 3 is an illustration of output port 130 of electronic device 100 in accordance with an illustrative embodiment of the invention. In the embodiment shown in FIG. 3, output port 130 comprises a DIN connector having five electrical contacts. In some embodiments, output port 130 may be mechanically compatible with a standard S-Video cable. Throughout this detailed description, “electrical contacts” includes both pins (male DIN connector) and holes/sockets (female DIN connector). Thus, output port 130 may be of either gender. However, as those skilled in the art will recognize, most notebook computers include female DIN connectors. Output port 130 may include luma contact 305, chroma contact 310, ground contacts 315 and 320, and digital audio signal (e.g., SPDIF audio) contact 325. Luma contact 305, chroma contact 310, and ground contacts 315 and 320 may output an S-Video-compatible video signal from video subsystem 120. Ground contacts 315 and 320, along with shield 330, may be electrically connected with ground 335. In this particular embodiment, digital audio is output from audio subsystem 125 over what those skilled in the audio art refer to as an “unbalanced” connection. That is, ground 335 is shared between electronic device 100 and an audiovisual system with which it is connected (not shown in FIG. 3). Specifically, digital audio signal contact 325 may be electrically connected with the output of resistor network 340, and the digital audio signal may share ground 335 with ground contacts 315 and 320.

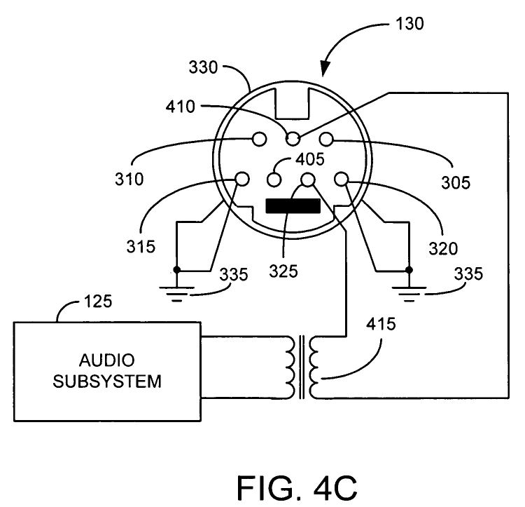

FIGS. 4A-4C are illustrations of output port 130 of electronic device 100 in accordance with three different illustrative embodiments of the invention. In each embodiment, output port 130 comprises a DIN connector having seven electrical contacts. However, the principles of the invention are applicable to any DIN connector having at least five electrical contacts.

In FIG. 4A, digital audio is output from audio subsystem 125 over an unbalanced connection in a manner similar to that shown in FIG. 3. Digital audio signal contact 325 is connected as shown in FIG. 3, the digital audio signal sharing ground 335 with ground contacts 315 and 320. In FIGS. 4A-4C, composite video contact 405 may output composite video (e.g., NTSC) from video subsystem 120 in addition to the S-Video-compatible signal output over luma contact 305, chroma contact 310, and ground contacts 315 and 320. In the particular embodiment of FIG. 4A, contact 410 may remain unused.

The embodiment shown in FIG. 4B is an unbalanced configuration similar to that shown in FIG. 4A, except that contact 410 is connected with ground 335 and is used for a separate return ground path for the digital audio signal.

FIG. 4C illustrates what those skilled in the art refer to as a “balanced” or “professional” connection. In a balanced connection, the grounds of the transmitting and receiving devices are isolated, eliminating ground loop-problems that sometimes occur with unbalanced connections. In FIG. 4C, digital audio signal contact 325 and contact 410 are connected with audio subsystem 125 via transformer 415.

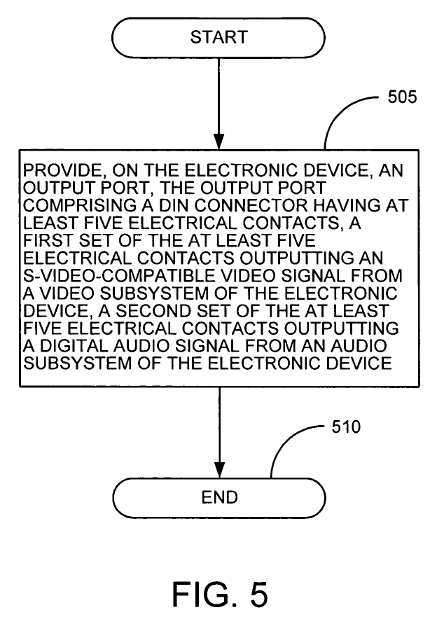

FIG. 5 is a flowchart of a method for facilitating connection of electronic device 100 with an audiovisual system in accordance with an illustrative embodiment of the invention. At 505, electronic device 100 is provided with an output port 130 comprising a DIN connector, the DIN connector having at least five electrical contacts. A first set of the at least five electrical contacts outputs an S-Video-compatible video signal and, optionally, a composite video signal from video subsystem 120. For example, in FIG. 3, the first set comprises luma contact 305, chroma contact 310, and ground contacts 315 and 320. In FIG. 4A-4C, the first set comprises those same electrical contacts plus composite video contact 405. A second set of the at least five electrical contacts outputs a digital audio signal (e.g., SPDIF audio) from audio subsystem 125. Where the audio signal shares ground 335 with the first set, the second set may comprise a single electrical contact (audio signal contact 325), as in FIGS. 3 and 4A. In FIG. 4B, the second set comprises audio signal contact 325 and contact 410 (separate return ground). In FIG. 4C, the second set again comprises audio signal contact 325 and contact 410, but those electrical contacts are connected with audio subsystem 125 via transformer 415. The method terminates at 510.

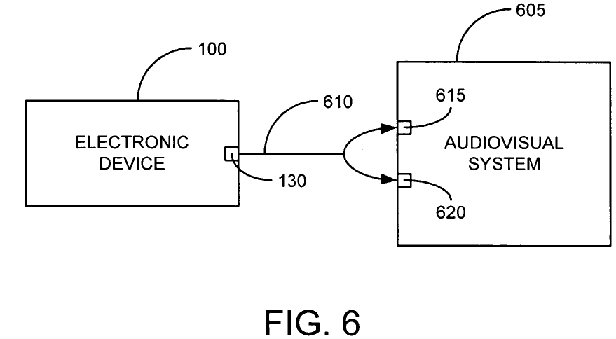

FIG. 6 is a block diagram of electronic device 100 connected with an audiovisual system 605 in accordance with an illustrative embodiment of the invention. A “Y” cable 610 may be connected at one end with output port 130, and the other end of cable 610 may be connected with separate audio (615) and video (620) inputs of audiovisual system 605. In other embodiments, cable 610 may be of the simple type (without a “Y”), if audiovisual system 605 has a single input port similar in design to output port 130 described above. In one illustrative embodiment, audiovisual system 605 comprises a home theater system. Such a home theater system typically includes an audio/video amplifier, three front speakers (left, center, and right), a pair of rear speakers, and a subwoofer. Output port 130 on electronic device 100 makes it easy for a user to connect such a device with audiovisual system 605.

The foregoing description of the present invention has been presented for the purposes of illustration and description. It is not intended to be exhaustive or to limit the invention to the precise form disclosed, and other modifications and variations may be possible in light of the above teachings. The embodiments were chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

What is claimed is:

1. An electronic device, comprising:
a video subsystem;
an audio subsystem;
an output port, the output port comprising a DIN connector having at least five electrical contacts; and
wherein a first set of the at least five electrical contacts outputs an S-Video-compatible video signal from the video subsystem and a second set of the at least five electrical contacts outputs a digital audio signal from the audio subsystem.

2. The electronic device of claim 1, wherein the output port has at least six electrical contacts and the first set outputs a composite video signal from the video subsystem in addition to the S-Video-compatible video signal.

3. The electronic device of claim 1, wherein the DIN connector is female in gender.

4. The electronic device of claim 1, wherein the second set comprises a signal contact, the signal contact being distinct from the first set, the digital audio signal sharing an electrical ground with the first set.

5. The electronic device of claim 1, wherein the second set comprises a signal contact and a ground contact, the signal and ground contacts being distinct from the first set.

6. The electronic device of claim 1, wherein the second set comprises first and second contacts, the first and second contacts being distinct from the first set, the first and second contacts being electrically connected with the audio subsystem via a transformer in a balanced configuration.

7. The electronic device of claim 1, wherein the digital audio output by the second set comprises SPDIF digital audio.

8. The electronic device of claim 1, wherein the electronic device comprises a notebook computer.

9. An electronic device, comprising:
a video subsystem;
an audio subsystem;
an output port, the output port comprising a DIN connector having five electrical contacts; and
wherein first, second, third, and fourth contacts output an S-Video-compatible video signal from the video subsystem and a fifth contact outputs a digital audio signal from the audio subsystem, the first and second contacts outputting, respectively, chroma and luma signals, the third and fourth contacts being connected with an electrical ground that is common to both the S-Video-compatible video signal and the digital audio signal.

10. The electronic device of claim 9, wherein the DIN connector is female in gender.

11. The electronic device of claim 9, wherein the digital audio signal comprises SPDIF digital audio.

12. The electronic device of claim 9, wherein the electronic device comprises a notebook computer.

13. An electronic device, comprising:
a video subsystem;
an audio subsystem;
an output port, the output port comprising a DIN connector having seven electrical contacts; and
wherein first, second, third, and fourth contacts output an S-Video-compatible video signal from the video subsystem, a fifth contact outputs a composite video signal from the video subsystem, and at least a sixth contact outputs a digital audio signal from the audio subsystem, the first and second contacts outputting, respectively, chroma and luma signals, the third and fourth contacts being connected with an electrical ground.

14. The electronic device of claim 13, wherein the digital audio signal shares the electrical ground with the third and fourth contacts.

15. The electronic device of claim 13, wherein the digital audio signal is output by a signal contact and a ground contact, the signal contact comprising the sixth contact, the ground contact comprising a seventh contact that is connected with the electrical ground.

16. The electronic device of claim 13, wherein the digital audio signal is output by the sixth contact and a seventh contact, the sixth and seventh contacts being electrically connected with the audio subsystem via a transformer in a balanced configuration.

17. The electronic device of claim 13, wherein the DIN connector is female in gender.

18. The electronic device of claim 13, wherein the digital audio signal comprises SPDIF digital audio.

19. The electronic device of claim 13, wherein the electronic device comprises a notebook computer.

20. A method for facilitating connection of an electronic device with an audiovisual system, comprising:
providing, on the electronic device, an output port, the output port comprising a DIN connector having at least five electrical contacts, a first set of the at least five electrical contacts outputting an S-Video-compatible video signal from a video subsystem of the electronic device, a second set of the at least five electrical contacts outputting a digital audio signal from an audio subsystem of the electronic device.

21. The method of claim 20, wherein the output port has at least six electrical contacts and the first set outputs a composite video signal from the video subsystem in addition to the S-Video-compatible video signal.

22. The method of claim 20, wherein the DIN connector is female in gender.

23. The method of claim 20, wherein the digital audio output by the second set comprises SPDIF digital audio.

24. The method of claim 20, wherein the electronic device comprises a notebook computer.

25. The method of claim 20, wherein the audiovisual system comprises a home theater system.
